(19) United States
(12) Patent Application Publication
(10) Pub. No.: US 2015/0190852 A1
(43) Pub. Date: Jul. 9, 2015

(54) DEVICE FOR CLEANING A SPRAY GUN

(71) Applicant: FILLON TECHNOLOGIES, Faverolles (FR)

(72) Inventor: Patrick Saint, Chartres (FR)

(21) Appl. No.: 14/418,118

(22) PCT Filed: Jul. 15, 2013
(86) PCT No.: PCT/FR2013/051686

§ 371 Date: Jan. 29, 2015

(30) Foreign Application Priority Data
Jul. 31, 2012 (FR) 1257414

(51) Int. Cl. B08B 9/032; B05B 15/02

(52) U.S. Cl. CPC B08B 9/0321; B05B 15/0266

(57) ABSTRACT

A cleaning apparatus for cleaning a gun has an inlet for fluid, and outlet for the fluid, an inlet for gas, and an outlet for the gas. The cleaning apparatus includes a support structure, a fluid feed head carried by the structure and connectable to the paint inlet of the gun and a fluid reception system that includes a fluid reception nozzle having a fluid passage connectable at its inlet to the outlet of the gun for the fluid to be sprayed, and a gas removal duct connectable at its inlet to the gas outlet of the gun. The nozzle is mounted to move relative to the support structure, in a direction substantially parallel to the axis of the inlet of the fluid passage between a position where it is closer to the fluid feed head and a position where it is spaced apart from the fluid feed head.

The present invention relates generally to apparatus for cleaning a spray gun.

The invention relates more particularly to apparatus for cleaning a spray gun having a fluid inlet for fluid to be sprayed, which inlet is referred to as a “paint inlet”, a fluid outlet for said fluid to be sprayed, a gas inlet for pressured gas, and a gas outlet for said pressurized gas. Said cleaning apparatus comprises a support structure, a fluid feed head carried by said structure and connectable to said paint inlet of the gun, and a fluid and gas reception system. Said fluid and gas reception system comprises firstly a fluid reception nozzle having a fluid passage that is connectable at its inlet to the fluid outlet of the gun for the fluid to be sprayed, and that is connected at its outlet to collection means for collecting the sprayed fluid, and secondly a gas removal duct that is connectable at its inlet to the gas outlet of said gun.

The fluid outlet of the gun for the fluid to be sprayed corresponds to the paint outlet when the gun is used for spraying paint.

Cleaning apparatus such as the apparatus described above is known from the state of the art, and in particular from Document WO2010116070. In that cleaning apparatus, the feed head and the reception system are positioned relative to each other in such a manner that they can be connected at the same time respectively to the paint inlet of the spray gun and to the paint outlet of the spray gun.

The cleaning apparatus of Document WO2010116070 makes it possible to clean and then to dry a gun without disconnecting the gun from said apparatus.

The up-and-down mobility of the fluid feed head of the cleaning device of Document WO2010116070 also makes it possible to position certain guns, of different dimensions, that have their paint inlets situated at different distances along the axis of the outlet of the feed head.

However, it has been observed that other types of gun cannot be positioned reliably in that cleaning apparatus known from the state of the art. In particular, that cleaning apparatus does not make it possible simultaneously to connect the paint inlet of the gun to the outlet of the feed head, and to connect the paint outlet of the gun to the inlet of the nozzle of the reception system, for guns having different distances between their paint inlets and their paint outlets, as measured in projection along the paint inlet axis onto the paint outlet axis. In simplified manner, it could be considered that such guns that are not compatible with the cleaning apparatus known from the state of the art are guns that have different barrel lengths relative to a reference point of the gun that corresponds to the projection of the paint inlet, along its axis, onto the paint outlet axis.

The axis of the paint inlet of the gun corresponds to the axis perpendicular to the midplane passing through the discharge opening of the paint outlet of the gun, and the axis of the paint outlet of the gun corresponds to the axis perpendicular to the midplane passing through the discharge opening of the paint inlet of the gun.

An object of the present invention is to propose cleaning apparatus that enables guns having different barrel lengths to be positioned easily and reliably in said cleaning apparatus.

Another object of the invention is to enable guns having barrel outside diameters that are of small size to be cleaned reliably.

To this end, the invention provides a cleaning apparatus as described in the above introduction, said apparatus being characterized in that said reception nozzle is mounted to move relative to the support structure, in a direction that is substantially parallel to the axis of the inlet of the fluid passage of the reception nozzle between a position in which it is closer to the fluid feed head and a position in which it is spaced apart from said fluid feed head.

The mobility of the fluid reception nozzle enables guns that have different barrel lengths to be positioned inside the cleaning device of the invention. In particular, the mobility of the nozzle enables it to move along an axis that is substantially parallel to the axis of the paint outlet of the gun, when said gun is pressed against the inlet of the nozzle of the reception system, optionally via an adapter as described in detail below, thereby enabling the reception system to absorb extra length of the barrel of the gun compared with another gun of shorter barrel length.

By means of the apparatus of the invention, it is thus possible simultaneously to connect the paint inlet of the gun to the fluid feed head and to connect the paint outlet of the gun to the inlet of the nozzle of the reception system, for guns having barrels that are of different lengths, i.e. for guns having different distances between their paint inlets and their paint outlets, as measured in projection along the paint inlet axis onto the paint outlet axis.

In accordance with an advantageous characteristic of the invention, the fluid and gas reception system further comprises a body that is stationary relative to the support and in which a recess is provided, inside which recess the fluid reception nozzle is mounted to slide.

In accordance with an advantageous characteristic of the invention, the reception system further comprises anti-rotation means for preventing the fluid reception nozzle from moving in rotation relative to the recess inside which said fluid reception nozzle is mounted to slide.

In accordance with an advantageous characteristic of the invention, said apparatus further comprises resilient return means for resiliently urging the fluid reception nozzle back into a position in which it is closer to the fluid feed nozzle.

Resiliently urging the nozzle back into the closer position makes it possible to maintain the inlet of the nozzle directly or indirectly pressing against the outlet of the gun.

In accordance with an advantageous characteristic of the invention, the reception system further comprises a gas reception chamber in which the reception nozzle extends at least partially, and into which the inlet of the gas removal duct discharges, and, secondly a sealing member that, when the barrel of the gun is in the state in which it is pressed against the sealing member, is suitable for co-operating with the outer peripheral wall of the fluid reception nozzle and with the barrel of the gun to define a sealed communication space via which the inlet of the gas removal duct communicates with the gas outlet of the gun.

In accordance with an advantageous characteristic of the invention, said sealing member is suitable for sliding inside the gas reception chamber, in a direction that is substantially parallel to the direction of sliding of the reception nozzle, between a position in which it is closer to the gas removal duct and a position in which it is spaced apart from said gas removal duct.

In accordance with an advantageous characteristic of the invention, said sealing member is urged back by resilient return means against an inner peripheral abutment provided at the end of the gas reception chamber that is situated on the same side as the inlet of the fluid passage of the reception nozzle.

In accordance with an advantageous characteristic of the invention, said sealing member is suitable for swiveling in the manner of a ball joint inside said gas reception chamber.

In accordance with an advantageous characteristic of the invention, said sealing member, which is of the tubular type, has a peripheral wall that extends through the inner peripheral abutment of the gas reception chamber, said peripheral wall of the sealing member defining an opening suitable for being connected to the gas outlet of the gun to enable sealed communication to be established between the gas outlet of the gun and the volume defined between the peripheral wall of the chamber and the reception nozzle, in the state in which the gun is pressed against the sealing member.

In accordance with an advantageous characteristic of the invention, said peripheral wall of the sealing member is extended, on the inside of the chamber, by a shoulder suitable for coming into abutment against said inner peripheral abutment provided at the end of the chamber.

In accordance with an advantageous characteristic of the invention, for a gun in which the outer peripheral wall of the barrel is of size less than the size of the opening defined by the sealing member, said apparatus further comprises an adapter that is suitable for being mounted on the end of the sealing member. Said adapter has a wall through which a preferably central first through passage is provided, suitable for putting the fluid outlet of the gun into communication with the inlet of the fluid passage of the reception nozzle, in the state in which the gun is pressed against the adapter. A second through passage is also provided in said wall and is suitable for putting the gas outlet of the gun into communication with the passage defined between the outer peripheral wall of the gas reception chamber and the fluid reception nozzle, in the state in which the gun is pressed against the adapter. In the state in which the adapter is mounted on the sealing member, said wall of the adapter has a concave, e.g. conical, surface, with the concave side facing away from the reception nozzle.

Said wall of the adapter reduces the opening in said sealing member in such a manner that, when the gun is in the state in which its pressed against the adapter, firstly the outlet of the gun for the fluid to be sprayed communicates in sealed manner with the inlet of the fluid reception nozzle, and secondly the gas outlet of the gun communicates in sealed manner with the gas removal duct.

This adapter makes it possible to obtain good sealing of the gas reception chamber that puts the fluid outlet of the gun into communication with the gas removal duct. Thus, the gas that is expelled via the fluid outlet of the gun and that goes through the corresponding openings of the adapter is removed via the gas removal duct of the reception system and not between the sealing member partially housed in said gas reception chamber and the outer casing or covering of the barrel of the gun, as it would be in the absence of such an adapter.

The invention can be well understood on reading the following description of embodiments given with reference to the accompanying drawings, in which:

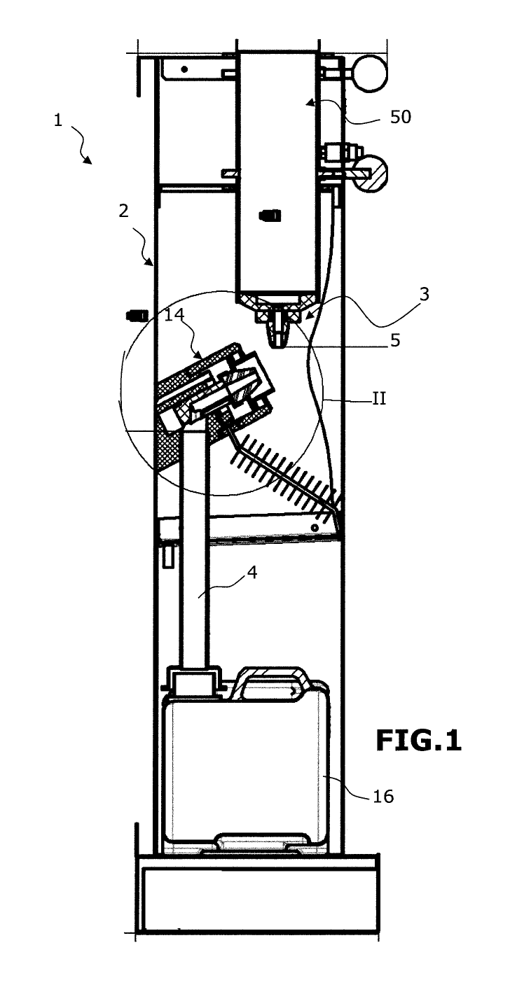

FIG. 1 is a section view of the cleaning apparatus of the invention in the absence of any gun to be cleaned;

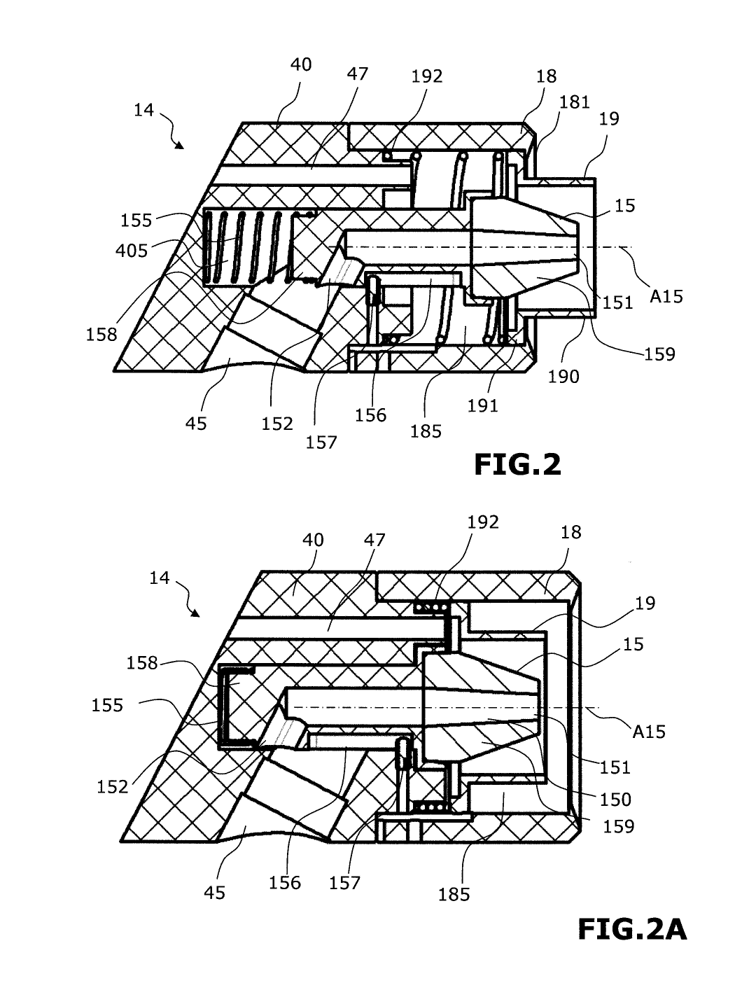

FIG. 2 is a detail view in axial section of the fluid and gas reception system of the zone II of FIG. 1, when said nozzle is in the state in which it is urged back into the position in which it is closer to said fluid feed head;

FIG. 2A is a view of the reception system of FIG. 2, when said nozzle is in the position in which it is spaced apart from said fluid feed head;

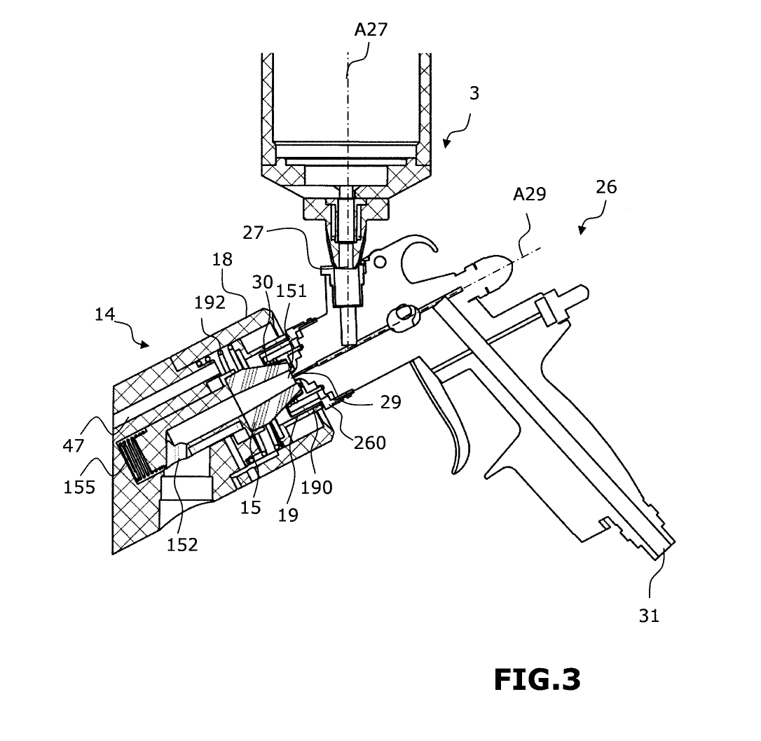

FIG. 3 is a view of the reception system and of the feed head of the apparatus of the invention when a first gun is in the state in which it is connected to said reception system and to said feed head;

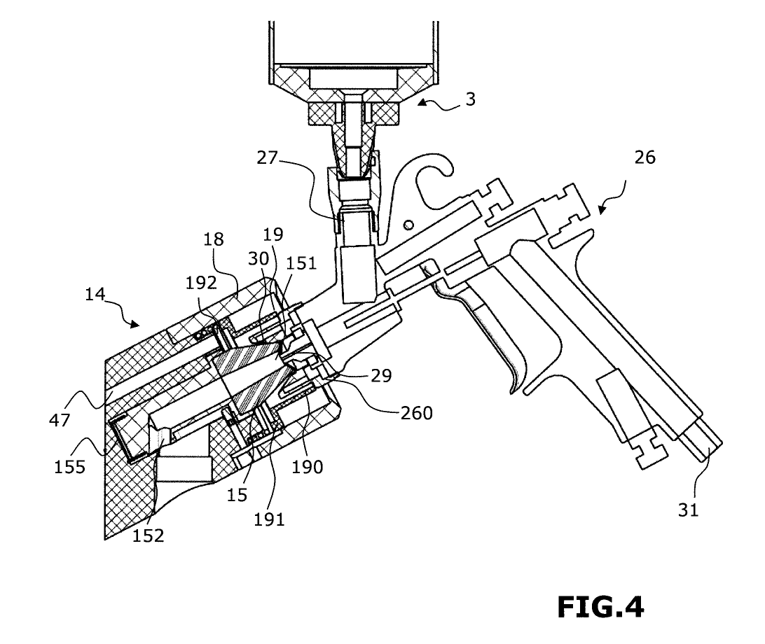

FIG. 4 is a view of the reception system and of the feed head of the apparatus of the invention when a second gun is in the state in which it is connected to said reception system and to said feed head;

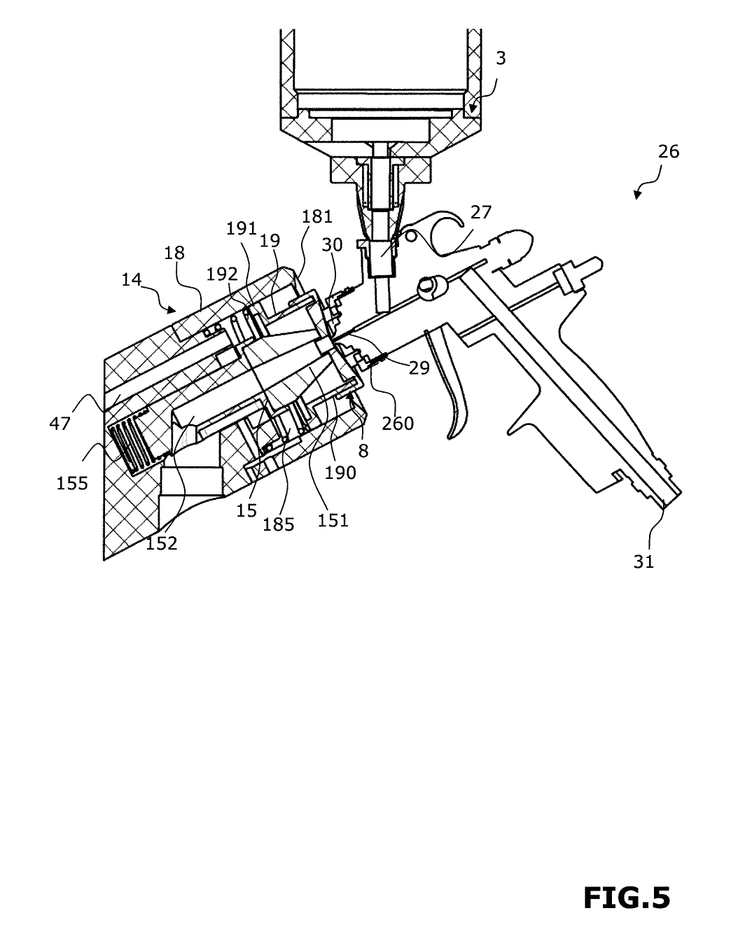

FIG. 5 is a view of the reception system and of the feed head of the apparatus of the invention when a third gun is in the state in which it is connected to said reception system and to said feed head;

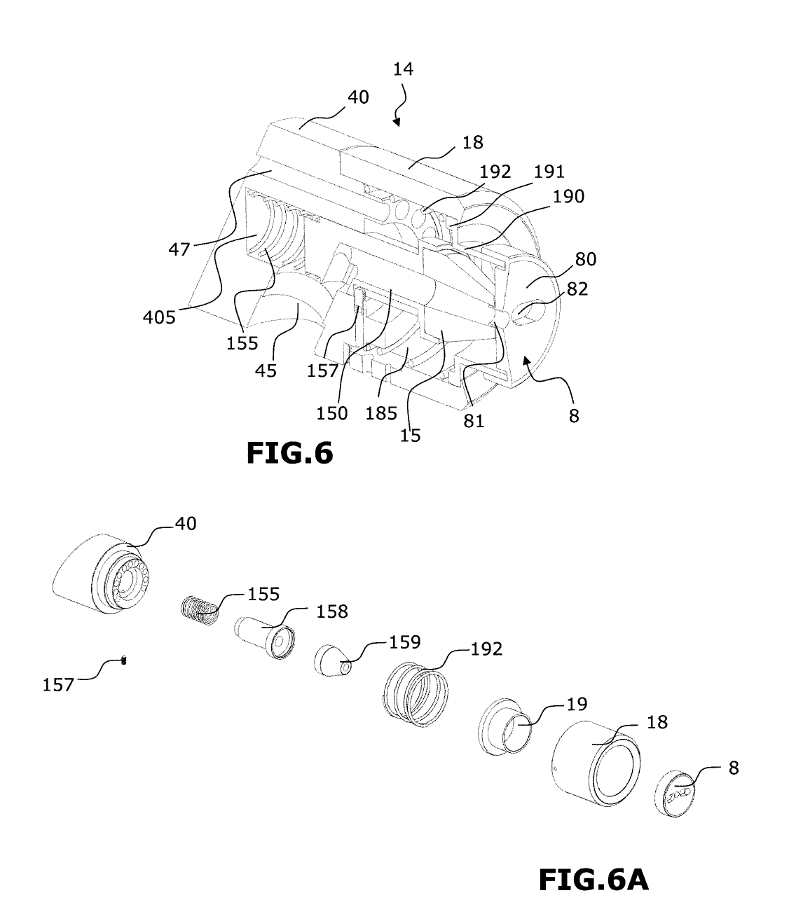

FIG. 6 is a perspective view in axial section of the liquid and gas reception system of the FIG. 2; and

FIG. 6A is an exploded view of the liquid and gas reception system of FIG. 2.

As indicated above, the cleaning apparatus 1 of the invention has a support structure 2 defining a cleaning volume, such as an enclosure, suitable for at least partially receiving a spray gun 26 to be cleaned.

The spray gun 26 is provided, in particular, with a fluid inlet 27 for receiving the fluid to be sprayed, which inlet is referred to as a “paint inlet” 27, and has an axis referenced A27, and with a fluid outlet 29, referred to as a “paint outlet”, having an axis referenced A29. An internal duct connects the paint inlet 27 to the paint outlet 29 of the gun 26.

Such a gun is also provided with a gas inlet 31 that is connectable to a gas feed source such as a compressed air feed source. This air inlet 31 makes it possible, in particular, to help the paint flow from the paint inlet 27 to the fluid outlet 29, and to be ejected from said gun when the trigger of the gun is actuated. Said air inlet 31 also makes it possible to feed a gas outlet 30 of the gun that serves to adjust the shape of the fluid flow. Generally, the gas outlet 30 of the gun is made up of a plurality of preferably radial outlet orifices that are referred to as “pressurized gas outlet” orifices, and that serve to adjust the shape of the paint flow exiting from the axial outlet.

In the example shown in the figures, the gas outlet is made up of outlet orifices disposed around the axial outlet 29 of the gun 26. When the spray gun 26 is used for painting, a paint cup (not shown) is connected to the paint inlet 27. The paint then exits via said axial outlet 29.

As shown in FIG. 1, the support structure 2 carries a fluid feed head 3 including a feed nozzle 5 designed to be connected to the paint inlet 27 of the spray gun 26 to be cleaned.

The feed nozzle 5 is coupled to the structure 2 of the cleaning apparatus 1 via a nozzle carrier 50. The nozzle carrier 50 is in the shape of a tubular body of vertical axis that, at its bottom end, is equipped with the feed nozzle 5 and, at its top end, is open so as to form an opening for inserting a cleaning fluid source, such as an aerosol recipient, inside said nozzle carrier 50.

The nozzle carrier 50 is movable relative to the structure 2 in up-and-down movement. Thus, for positioning the feed nozzle 5 and the reception system 14 respectively at said paint inlet 27 and at said outlet 29 of the spray gun, it is possible to adjust the height of the feed nozzle 5 to match the height of the paint inlet 27 of the gun, and to absorb extra length of the barrel 260 of the gun 26 by means of the mobility of the reception nozzle 15 that is described in detail below, thereby making it possible to connect guns of different dimensions to the feed nozzle 5 and to the reception system 14, as shown more particularly in FIGS. 3 to 5.

Said guns may differ with respect to the dimensions of their paint inlets, to the dimensions of their outlets, to the distances between the paint inlets and the outlets of the guns, and to the relative directions in which the paint inlets and the outlets of the guns point.

The cleaning apparatus includes a fluid and gas reception system 14 designed to be connected to the outlets 29 and 30 of the gun 26. In order to be able to separate the fluid ejected at the outlet 29 and coming from the inlet 27 of the gun from the gas ejected by the outlet 30 of the gun and coming from the gas inlet 31, the reception system 14 is provided firstly with a reception nozzle 15 having a fluid passage 150 that is connectable at its inlet 151 to the fluid outlet 29 of the gun, via which outlet the fluid to be sprayed exits, and that is connectable at its outlet 152 to collection means 16 for collecting the sprayed fluid, and secondly with a gas removal duct 47 that is connectable at its inlet to the gas outlet 30 of said gun 26 via a recuperation chamber 185 that is described in detail below. Said gas removal duct 47 discharges at its outlet into a “gas removal zone” that is distinct from the collection means 16 for collecting the sprayed fluid flow.

The collection means 16 for collecting the sprayed fluid flow comprise a reservoir connected via a duct 4 to the outlet 152 of the fluid reception nozzle 15 of the reception system 14.

When it is to be cleaned, the spray gun 26 is connected to the cleaning apparatus 1. More precisely, the paint cup is withdrawn and the paint inlet 27 is connected to the feed nozzle 5 of the feed head 3. The paint outlet 29 and the gas outlet 30 are pressed against the reception system 14 so as to be connected respectively to the inlet 151 of the fluid reception nozzle and to the inlet of the gas removal duct, via a gas reception chamber 185 as explained in detail below.

The feed head 3 can be controlled to cause the cleaning fluid to flow. An embodiment of the feed head 3 and of the structure 2 is described in detail in Patent Application WO2010116070.

The feed head 3 has a feed nozzle 5 that is provided with at least two independent inlets for feeding fluid to it. Each of said inlets discharges at a distinct orifice into the duct of said feed nozzle 5. One of said inlets is connectable to a cleaning fluid source, and the other is connectable to a compressed air source.

Thus, in the state in which the inlets of the feed nozzle 5 are connected to their respective fluid sources during the cleaning stage, the cleaning fluid feeds the feed nozzle 5 via an inlet and goes successively via the paint inlet 27, via the internal duct, and via the axial paint outlet 29 of the gun.

During the drying stage, the compressed air feeds the feed nozzle 5, via the other inlet of the feed nozzle 5, and goes successively via the paint inlet 27, via the internal duct, and via the axial outlet 29 of the gun. This drying makes it possible to remove the cleaning fluid remaining in the internal duct of the gun between the inlet 27 and the outlet 29 of said gun.

The feed head 3 is disposed at or in the vicinity of the top of the structure, and thus extends essentially above the gun in the state in which the gun is inserted into the cleaning volume.

Said reception nozzle 15 is mounted to move relative to the support structure 2, in a direction that is substantially parallel to the axis A15 of the inlet 151 of the fluid passage 150 of the reception nozzle 15 between a position in which it is closer to the fluid feed head 3 and a position in which it is spaced apart from said fluid feed head 3.

In other words, for any given position of the feed nozzle 5, the distance, as projected along said axis A15 of the inlet of the reception nozzle 15, between the inlet 151 of the reception nozzle 15 when it is in the closer position and the outlet of the feed nozzle 5 is less than the distance, as projected along said axis A15, between the inlet 151 of the reception nozzle 15 when said reception nozzle 15 is in the spaced-part position and the outlet of the feed nozzle 5 when said reception nozzle 15 is in the spaced-apart position.

The axis A15 of the inlet 151 of the fluid passage 150 of the reception nozzle 15 corresponds to an axis orthogonal to the midplane passing through the mouth of the inlet 151 of the fluid passage 150. In the example shown in the figures, said axis coincides with the axis of the nozzle 15.

The mobility of the fluid reception nozzle 15 thus makes it possible simultaneously to connect the paint inlet 27 of the gun 26 to the fluid feed head 5 and to connect the paint outlet 29 of the gun to the inlet 151 of the nozzle of the reception system 14, for guns having barrels that are of different lengths, i.e. for guns having different distances between their paint inlets 27 and their paint outlets 29, as measured in projection along the axis A27 of the paint inlet 27 onto the axis A29 of the paint outlet 29.

The reception system 14 includes a body 40 that is stationary relative to the structure 2 in which a recess 405 is provided inside which the reception nozzle 15 is mounted to slide. A duct 45 is provided in the body 40 of the reception system 14. One end of the duct 45 discharges into the recess 405 inside which the reception nozzle 15 is mounted to slide, and the other end of said duct is connected via the duct 4 to the fluid collection reservoir 16.

In particular, said reception nozzle 15 includes a cylindrical body 158 to which a nozzle head 159 is coupled, said inlet 151 of the fluid passage 150 discharging at the free end of said nozzle head. Said nozzle body 158 is mounted inside said recess 405.

When in the state in which it is connected to said axial outlet 29, said reception nozzle 15 is suitable for preventing any action by the gas coming from the gas outlets 30 on the fluid flow exiting from the axial outlet 29. In other words, the fluid flow exiting from the axial outlet 29 of the gun 26 is isolated from the gas flow exiting from the gas outlet 30 of the gun 26.

As shown more particularly in FIGS. 2 and 2A, the reception system 15 is provided with anti-rotation means 156, 157 for preventing the reception nozzle 15 from moving in rotation relative to the recess 405 inside which said reception nozzle 15 is mounted to slide. Said anti-rotation means 156, 157 comprise a groove 156 provided in the cylindrical body of the reception nozzle 15 in a direction that is substantially parallel to the direction in which the reception nozzle 15 slides, and a pin 157 secured to or integral with the body of the recess and that extends in said groove (perpendicularly) to the axis of the groove.

Said apparatus 1 further includes resilient return means 155 for resiliently urging the reception nozzle 15 back into the position in which it is closer to said fluid feed nozzle 3. Said resilient return means 155 for resiliently urging the reception nozzle 15 back comprise a resilient member, such as a spring, having one end secured to the recess 405 of the reception system 14, and having its opposite end secured to the reception nozzle 15.

The reception system 14 also includes a gas reception chamber 185 in which the reception nozzle 15 extends at least partially, and into which the inlet of the gas removal duct 47 discharges. Said reception chamber 185 houses a sealing member 19 that is suitable, when the barrel of the gun is in the state in which it is pressed against the sealing member 19, for co-operating with the outer peripheral wall of the reception nozzle 15 and with the outer peripheral wall of the barrel 260 of the gun to define a sealed annular space via which the inlet of the gas removal duct 47 communicates with the gas outlet 30 of the gun 26. In particular, the sealing member 19 defines an opening that is suitable for being connected to the gas outlet 30 of the gun so as to enable the gas outlet 30 to communicate in sealed manner with the volume defined between the peripheral wall of the chamber 185 and the reception nozzle 15.

Said sealing member 19 is loaded by a spring 192 and forms a tilt-accommodating swivel ring as described in detail below.

The gas removal duct 47 is connectable at its inlet to the gas outlet 30 of said gun, via said sealing member 19 described in detail below. The gas removal duct 47 discharges at its outlet into a “gas removal zone” that is distinct from the means 16 for collecting the sprayed fluid flow in order to remove the gas form the gun into a removal zone.

The outer peripheral wall of the gas reception chamber 185 is formed by a ring 18 surrounding said nozzle 15, in particular the frustoconical portion of said nozzle 15.

The inlet of the gas removal duct 47 discharges into the space defined between the wall of the ring 18 and the reception nozzle 15.

The sealing member 19 has a peripheral wall 190 of diameter slightly less than the inside diameter of the ring 18. Said peripheral wall 190 of the sealing member is extended on the inside of the chamber 185 by a shoulder 191 that is suitable for coming into abutment against an inner radial abutment 181 provided at the end of the chamber 185. The sealing member 19 can slide along the ring 18 between a position in which the spring 192 is compressed, and a return position into which the sealing member 19 is urged back against said inner radial abutment 181 provided at the free end of the ring 18, into which said sealing member is urged.

Advantageously, the peripheral wall 190 of said sealing member 19 has a convex outer peripheral surface so as to swivel in the manner of a ball-joint about the fluid reception nozzle 15, thereby accommodating tilt so as to guarantee good sealing of the communication passage between the gas outlet 30 of the gun and the gas removal duct 47, and good sealing of the communication passage between the outlet 29 of the gun and the inlet 151 of the reception nozzle when the gun 26 needs to be inclined slightly relative to the axis of the nozzle in order to connect the paint inlet 27 to the feed nozzle 5 and in order to connect the axial outlet 29 to the inlet 151 of the reception nozzle.

Since the sealing member or gasket 19 provides the sealing relative to the barrel of the gun, the clean air exiting from the outlet 30 and coming from the inlet 31 of the gun is forced to be removed via the gas removal duct 47 and is brought to the atmosphere so that the volume of fluid to be treated that is collected in the collection means is smaller than in the state of the art.

When the sealing member 19 is in the state in which it urged back against the inner radial abutment 181, the peripheral wall 190 of the sealing member extends so that it protrudes from said inner radial abutment 181. By bringing the sealing member to protrude, it is possible, depending on the types of gun, to ensure that the barrel 260 of the gun 26 comes to press firstly against the sealing member 19 before the paint outlet 29 of the gun is pressed against the nozzle 15, thereby making it possible to obtain good sealing of the space defined between the sealing member 19, the ring 18, and the nozzle 15, which space communicates with the connection duct 47. In addition, by bringing the sealing member 19 to protrude, it is possible, as shown more particularly in FIG. 5, to put an adapter 8 for a mini-gun in place and to hold it in place on the peripheral wall 190 of the sealing member 19.

FIG. 3 shows the situation when a gun having a given barrel length is positioned in the cleaning apparatus of the invention. The paint inlet 27 is connected to the outlet of the feed head 3 and the outlet of the gun is aligned with the inlet 151 of the reception nozzle 15 by the barrel of the gun coming into pressing contact against the reception nozzle 15 that can retract to a given position by means of it being slidably movable so as to enable the gun to be positioned correctly in the cleaning apparatus.

FIG. 4 shows the situation in which another gun having a barrel length greater than the barrel length of the gun of FIG. 3 is positioned. As in the example shown in FIG. 3, the paint inlet 27 is connected to the outlet of the feed head 3 and the outlet 29 of the gun is aligned with the inlet 151 of the reception nozzle 15. In the example shown in FIG. 4, the extra length of the barrel of the gun, compared with the length of the barrel of the gun in FIG. 3, is absorbed by the cleaning device by means of the reception nozzle 15 being slidably movable. Thus, in the example shown in FIG. 4, the reception nozzle 15 is pushed back by the barrel of the gun 26 into a position that is different from its position in FIG. 3. In the example shown in FIG. 4, the return spring for urging the nozzle 15 back is compressed to a greater extent than it is in the example shown in FIG. 3, in which the barrel of the gun is shorter.

The tilt-accommodating sealing member 19 makes it possible, in combination with the slidably movable reception nozzle 15, for the outlet 29 of the gun to be inserted into the ring 18 with, if necessary, a given inclination, so as then to enable said outlet 29 to be aligned with the inlet 151 of the reception nozzle 15 while also enabling the paint inlet 27 to be connected to the outlet of the feed head 3.

It can be observed that, for guns of different lengths as shown in FIGS. 3 and 4, the device of the invention, by means of the reception nozzle being slidably movable, makes it possible to align the inlet of the reception nozzle 15 with the outlet 29 of the gun 26, and to align the paint inlet 27 of the gun with the outlet of the feed head 3. In particular, regardless of the sliding position of the reception nozzle 15, the outlet 152 of the fluid passage 150 of the reception nozzle remains in communication with the collection means 16 so as to enable the dirty cleaning fluid exiting from the gun 26 to be collected.

The adapter 8 for a mini-gun is described in detail below.

As shown in FIG. 5, for a gun 26 of the mini-gun type, in which the outer peripheral wall of the barrel is of size smaller than the size of the opening defined by the sealing member 19, said apparatus includes an adapter 8 that is suitable for being mounted on the end of the sealing member 19.

Said adapter 8 has a preferably central first through passage 81 suitable for putting the fluid outlet 29 of the gun into communication with the inlet 151 of the fluid passage 150 of the reception nozzle 15, in the state in which the gun 26 is pressed against the adapter. Said adapter 8 also has a second through passage 82 suitable for putting the gas outlet 30 of the gun into communication with the volume defined between the peripheral wall of the chamber 185 and the reception nozzle 15, when the gun is in the state in which it is pressed against the adapter 8.

Said adapter 8 also has a wall 80 that is preferably conical in general shape with its concave side facing towards the outside of the sealing member, and that, when the adapter 8 is in the state in which it is mounted on the sealing member 19, reduces the opening of said sealing member 19 in such a manner as to enable firstly the fluid-to-be-sprayed outlet 29 of the gun 26 as pressed against the adapter 8 to communicate in sealed manner with the inlet of the reception nozzle 15 and secondly the gas outlet 30 of the gun 26 as pressed against the adapter 8 to communicate in sealed manner with the removal duct 47.

Thus, the wall of the barrel, or the covering of the barrel, that extends around the fluid-to-be-sprayed outlet 29 and the external gas outlet 30 of the gun 26 can come to press against the sealing member 19 via said adapter 8 in order to put the gas outlet 30 of the gun into sealed communication with the volume defined between the peripheral wall of the chamber 185 and the reception nozzle 15, when the gun is in the state in which it is pressed against the adapter 8.

The outer peripheral edge of the opening-reducing wall 80 is provided with a lip for pressing against the outer face of the peripheral wall 190 of the sealing member 19. The lip and the opening-reducing wall of said adapter define between them a groove into which the free end of the peripheral wall 190 of the sealing member 19 can be inserted.

The portion of the barrel of the gun that extends around the outlet 30 of the gun is suitable for coming to press, directly or indirectly, against the peripheral wall 190 of said sealing member 19, while the portion of the barrel of the gun 26 that extends between the axial outlet 29 and the outlet 30 of the gun 26, comes to press directly or indirectly against the portion of the nozzle 15 that surrounds the inlet 151 of said nozzle.

As shown more particularly in FIGS. 3 and 4, when the outlets 29, 30 of the gun are in the state in which they are connected to the reception system 14, the sealing member 19 surrounds the barrel of the gun with sealed pressing contact and prevents the air exiting from the end of the barrel of the gun via the gas outlets 30 from escaping from the volume defined by the ring 18, by the nozzle 15, and by said sealing member 19, and with which the inlet of the gas removal duct 47 communicates.

It should be noted that the end of the reception nozzle 15 is preferably made of an elastically deformable material. It can be seen that the reception nozzle 15 has a cylindro-conical shape. This enables the reception nozzle 15 to be connected to guns having paint outlets of different diameters.

As stated above, said gas removal duct 47 has an inlet that discharges into the passage formed by the space left free between the ring 18 and the reception nozzle 15, in particular the frustoconical portion of said nozzle 15, and an opposite end or outlet that discharges into the gas removal zone. In the examples shown, the gas removal zone is formed by the ambient air surrounding the cleaning device so that said gas removal duct discharges into the surrounding air.

To this end, in its “rear” zone, opposite from its “front” zone, the support structure 2 has at least one opening and preferably a plurality of openings corresponding to the gas removal duct(s) discharging into the surrounding air.

Advantageously, said reception member 14 has a plurality of gas removal ducts 47. Said ducts are disposed equidistantly from the axis of the reception nozzle 15. Thus, the inlets of the gas removal ducts 47 in the space formed between the ring 18 and the reception nozzle 15 are disposed on a circle of centre situated on the central axis of the reception nozzle. The possibilities of removing gas to the atmosphere are thus increased.

During a cleaning stage, the cleaning fluid leaves the feed head 3 and goes successively via the feed nozzle 5, via the paint inlet 27, via the internal duct 29 of the gun, and via the reception member 14, and then arrives in the collection means 16.

The cleaning fluid thus flows in a closed circuit from the feed head 3 to the collection means 16.

After the cleaning fluid has been caused to flow, the admission head 3 can be controlled to cause the pressurized air to go into the above-mentioned closed circuit in order to dry the spray gun and more precisely in order to remove any cleaning fluid remaining the in the internal duct.

The present invention is in no way limited to the embodiments described and shown, and the person skilled in the art can make any variant to them that lies within the spirit of the invention.

1. Apparatus (1) for cleaning a spray gun (26), said gun (26) having a fluid inlet (27) for fluid to be sprayed, which inlet is referred to as a “paint inlet” (27), a fluid outlet (29) for said fluid to be sprayed, a gas inlet (31) for pressurized gas, and a gas outlet (30) for said pressurized gas;
said cleaning apparatus (1) comprising:
a support structure (2);
a fluid feed head (3) carried by said structure (2) and connectable to said paint inlet (27) of the gun (26); and
a fluid and gas reception system (14) that comprises:
firstly a fluid reception nozzle (15) having a fluid passage (150) that is connectable at its inlet (151) to the fluid outlet (29) of the gun for the fluid to be sprayed, and that is connected at its outlet (152) to collection means (16) for collecting the sprayed fluid; and
secondly, a gas removal duct (47) that is connectable at its inlet to the gas outlet (30) of said gun (26);
said apparatus being characterized in that said reception nozzle (15) is mounted to move relative to the support structure (2), in a direction that is substantially parallel to the axis of the inlet (151) of the fluid passage (150) of the reception nozzle (15) between a position in which it is closer to the fluid feed head (3) and a position in which it is spaced apart from said fluid feed head (3).

2. Apparatus (1) according to claim 1, characterized in that the fluid and gas reception system (14) further comprises a body (40) that is stationary relative to the support (2) and in which a recess (405) is provided, inside which recess the fluid reception nozzle (15) is mounted to slide.

3. Apparatus (1) according to claim 2, characterized in that the reception system (14) further comprises anti-rotation means (156, 157) for preventing the fluid reception nozzle (15) from moving in rotation relative to the recess (405) inside which said the fluid reception nozzle (15) is mounted to slide.

4. Apparatus (1) according to claim 1, characterized in that said apparatus (1) further comprises resilient return means (155) for resiliently urging the fluid reception nozzle (15) back into a position in which it is closer to the fluid feed nozzle (3).

5. Apparatus (1) according to claim 1, characterized in that the reception system (14) further comprises a gas reception chamber (185) in which the reception nozzle (15) extends at least partially, and into which the inlet of the gas removal duct (47) discharges, and, secondly a sealing member (19) that, when the barrel of the gun is in the state in which it is pressed against the sealing member (19), is suitable for co-operating with the outer peripheral wall of the fluid reception nozzle (15) and with the barrel (260) of the gun to define a sealed communication space via which the inlet of the gas removal duct (47) communicates with the gas outlet (30) of the gun (26).

6. Apparatus (1) according to claim 5, characterized in that said sealing member (19) is suitable for sliding inside the gas reception chamber (185), in a direction that is substantially parallel to the direction of sliding of the reception nozzle (15), between a position in which it is closer to the gas removal duct (47) and a position in which it is spaced apart from said gas removal duct (47).

7. Apparatus (1) according to claim 6, characterized in that said sealing member (19) is urged back by resilient return means (192) against an inner peripheral abutment (181) provided at the end of the gas reception chamber (185) that is opposite from the gas removal duct.

8. Apparatus (1) according to claim 7, characterized in that said sealing member (19), which is of the tubular type, has a peripheral wall (190) that extends through the inner peripheral abutment (181) of the gas reception chamber (185), said peripheral wall (190) of the sealing member (19) defining an opening suitable for being connected to the gas outlet (30) of the gun to enable sealed communication to be established between the gas outlet (30) of the gun and the volume defined between the peripheral wall of the chamber (185) and the reception nozzle (15), in the state in which the gun (26) is pressed against said sealing member (19).

9. Apparatus (1) according to claim 7, characterized in that said peripheral wall (190) of the sealing member (19) is extended, on the inside of the chamber (185), by a shoulder (191) suitable for coming into abutment against said inner peripheral abutment (181) provided at the end of the chamber (185).

10. Apparatus (1) according to claim 5, characterized in that said sealing member (19) is suitable for swiveling in the manner of a ball joint inside said gas reception chamber (185).

11. Apparatus (1) according to claim 5, characterized in that, for a gun (26) in which the outer peripheral wall of the barrel is of size less than the size of the opening defined by the sealing member (19), said apparatus further comprises an adapter (8) that is suitable for being mounted on the end of the sealing member (19), said adapter (8) having a wall (80) through which the following are provided: firstly a preferably central first through passage (81), suitable for putting the fluid outlet (29) of the gun into communication with the inlet (151) of the fluid passage (150) of the reception nozzle (15), in the state in which the gun (26) is pressed against the adapter (8); and secondly a second through passage (82) suitable for putting the gas outlet (30) of the gun into communication with the passage defined between the outer peripheral wall of the gas reception chamber (185) and the fluid reception nozzle (15), in the state in which the gun (26) is pressed against the adapter (8); and in that, in the state in which the adapter (8) is mounted on the sealing member (19), said wall (80) of the adapter (8) has a concave, e.g. conical, surface, with the concave side facing away from the reception nozzle (15).

12. Apparatus (1) according to claim 2, characterized in that said apparatus (1) further comprises resilient return means (155) for resiliently urging the fluid reception nozzle (15) back into a position in which it is closer to the fluid feed nozzle (3).

13. Apparatus (1) according to claim 2, characterized in that the reception system (14) further comprises a gas reception chamber (185) in which the reception nozzle (15) extends at least partially, and into which the inlet of the gas removal duct (47) discharges, and, secondly a sealing member (19) that, when the barrel of the gun is in the state in which it is pressed against the sealing member (19), is suitable for co-operating with the outer peripheral wall of the fluid reception nozzle (15) and with the barrel (260) of the gun to define a sealed communication space via which the inlet of the gas removal duct (47) communicates with the gas outlet (30) of the gun (26).

14. Apparatus (1) according to claim 8, characterized in that said peripheral wall (190) of the sealing member (19) is extended, on the inside of the chamber (185), by a shoulder (191) suitable for coming into abutment against said inner peripheral abutment (181) provided at the end of the chamber (185).
